(19) United States
(12) Patent Application Publication
(10) Pub. No.: US 2025/0390644 A1
(43) Pub. Date: Dec. 25, 2025

(54) SYSTEM AND METHOD FOR BUILDING AN ELECTRIC VEHICLE CHARGING NETWORK

(71) Applicant: Walmart Apollo, LLC, Bentonville, AR (US)

(72) Inventors: Ashish Gupta, Bangalore (IN); Mandeep Singh, Bengaluru (IN); Achala Sharma, Bangalore (IN); Priyanshu Ranjan, Bangalore (IN); Sujay Anand Madbhavi, Bengaluru (IN); Abhijeet Pandey, Bhilai (IN); Kartikeya Gupta, Bengaluru (IN); Ankit Ajit Jain, Bangalore (IN); Abhishek Mishra, Bengaluru (IN); Rahul Ghosh, Bangalore (IN); Vishal Narendra Kapadia, Lexington, MA (US); Lloyd Andrew Lancelot, Bentonville, AR (US); Manish Manoharlal Rathi, Palo Alto, CA (US); Anup Varma Mantena, Scarsdale, NY (US); Matthew Benjamin Nelson, Falls Church, VA (US); Lawrence Isaac Daniel, Bentonville, AR (US); Ian Michael Hostetler, Dulles, VA (US); Yoshihisa Fujii, Bentonville, AR (US)

(21) Appl. No.: 19/246,470

(22) Filed: Jun. 23, 2025

Related U.S. Application Data
(60) Provisional application No. 63/663,304, filed on Jun. 24, 2024.

(51) Int. Cl. G06F 30/27; G06F 111/06; G06F 111/10; G06F 113/04; G06Q 50/06

(52) U.S. Cl. CPC G06F 30/27; G06Q 50/06; G06F 2111/06; G06F 2111/10; G06F 2113/04

(57) ABSTRACT

In some embodiments, a disclosed method includes: storing, in a database, historical data associated with existing electric vehicle charging stations, identifying a first set of locations for potential electric vehicle charging stations, determining demand forecast associated with the set of locations based on the historical data, generating a score value for each location of the first set of locations, the score value being based on the demand forecast, calculating a loss value for a first location of the first set of locations based on one or more of a second location of the first set of locations and a plurality of locations of the existing electric vehicle charging stations, and generating a second set of locations for potential electric vehicle charging stations based on the demand forecast, the score value, and the loss value, the second set being a subset of the first set.

### REFERENCE TO RELATED APPLICATIONS

This application claims priority to and the benefit of, U.S. Provisional Patent Application No. 63/663,304, filed on Jun. 24, 2024, which is incorporated by reference herein in its entirety.

### TECHNICAL FIELD

This application relates generally to building an electric vehicle charging network and, more particularly, to systems and methods for building an electric vehicle charging network comprised of a plurality of electric vehicle charging stations.

### BACKGROUND

The rapid increase in electric vehicles (EVs) is transforming the automotive industry and is important for reducing greenhouse gas emissions and dependency on fossil fuels. However, the widespread acceptance and continued growth of EVs are hindered by the availability of EV charging stations.

EV charging stations must be placed in strategic locations to reduce range anxiety of EV drivers and effectively reduce greenhouse gas emissions, while also providing financial incentives to the owner of the EV charging stations. Location selection for EV charging stations requires that each location be financially viable in terms of expected profit, while being strategically placed to reduce range anxiety of the users. Further, the EV charging stations must not self-cannibalize nearby location's potential revenue or use.

### SUMMARY

The embodiments described herein are directed to systems and methods for building an electric vehicle charging network.

In various embodiments, a system including a database storing historical data associated with existing electric vehicle charging stations, a computing device comprising at least one processor in communication with the database, the computing device being configured to identify a first set of locations for potential electric vehicle charging stations, determine demand forecast associated with the set of locations based on the historical data, generate a score value for each location of the first set of locations, the score value being based on the demand forecast, calculate a loss value for a first location of the first set of locations based on one or more of a second location of the first set of locations and a plurality of locations of the existing electric vehicle charging stations, and generate a second set of locations for potential electric vehicle charging stations based on the demand forecast, the score value, and the loss value, the second set being a subset of the first set.

In various embodiments, a computer-implemented method is disclosed. The computer-implemented method includes storing, in a database, historical data associated with existing electric vehicle charging stations, identifying a first set of locations for potential electric vehicle charging stations, determining demand forecast associated with the set of locations based on the historical data, generating a score value for each location of the first set of locations, the score value being based on the demand forecast, calculating a loss value for a first location of the first set of locations based on one or more of a second location of the first set of locations and a plurality of locations of the existing electric vehicle charging stations, and generating a second set of locations for potential electric vehicle charging stations based on the demand forecast, the score value, and the loss value, the second set being a subset of the first set.

In various embodiments, a non-transitory computer readable medium having instructions stored thereon is disclosed. The instructions, when executed by at least one processor, cause at least one device to perform operations including: storing, in a database, historical data associated with existing electric vehicle charging stations, identifying a first set of locations for potential electric vehicle charging stations, determining demand forecast associated with the set of locations based on the historical data, generating a score value for each location of the first set of locations, the score value being based on the demand forecast, calculating a loss value for a first location of the first set of locations based on one or more of a second location of the first set of locations and a plurality of locations of the existing electric vehicle charging stations, and generating a second set of locations for potential electric vehicle charging stations based on the demand forecast, the score value, and the loss value, the second set being a subset of the first set.

### BRIEF DESCRIPTION OF THE DRAWINGS

The features and advantages of the present disclosure will be more fully disclosed in, or rendered obvious by the following detailed description of the preferred embodiments, which are to be considered together with the accompanying drawings wherein like numbers refer to like parts and further wherein:

FIG. 1 is a network environment configured to build an electric vehicle (EV) charging network, in accordance with some embodiments of the present teaching.

FIG. 2 is a block diagram of an EV charging network forecaster, in accordance with some embodiments of the present teaching.

FIG. 3 is a flow diagram of a system for building an electric vehicle (EV) charging network, in accordance with some embodiments of the present teaching.

FIG. 4 is a flow diagram of an exemplary model for building an electric vehicle (EV) charging network, in accordance with some embodiments of the present teaching.

FIG. 5 is a table illustrating estimation of revised weights for generation of a score associated with a location for placement of an EV charging station, in accordance with some embodiments of the present teaching.

FIG. 6 is a table illustrating an exemplary method of preparing training data for determine loss data, in accordance with some embodiments of the present teaching.

FIG. 7 is a table illustrating the impact of loss in relation to distance, in accordance with some embodiments of the present teaching.

FIG. 8 is an illustration of an exemplary route, in accordance with some embodiments of the present teaching.

FIG. 9 is an illustration of a visual representation of a route cover function, in accordance with some embodiments of the present teaching.

FIG. 10 is an illustration of a Pareto Frontier visualization, in accordance with some embodiments of the present teaching.

FIG. 11 is a flow diagram of an exemplary model for building an EV charging network using the forecaster of FIG. 2, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for building an electric vehicle (EV) charging network In some embodiments, the systems and methods utilize models (e.g., machine learning models) to identify locations of EV charging stations. For example, the systems and method provided herein may identify locations that provide financial incentives to the owner of the EV charging network, while also locating the EV charging stations to reduce range anxiety of the users.

In some embodiments, the systems and methods provided herein breakdown each transportation carrier's journey and reconstructs the journey to provide an optimal route. An optimal route may be defined as the route with the least number of miles, the least number of miles driving while empty (e.g., no cargo or goods), and/or the least number of miles prior to beginning route.

In some embodiments, the systems and methods provided herein utilize one or more models to consider latent dimensions such as hardware technology and public policy. The one or more models may utilize historical data associated with existing EV charging stations and networks to forecast locations where EV charging stations are desired. In some embodiments, the systems and methods provided herein utilize one or more models to build a network of EV charging station locations to maximize financial performance, reduce self-cannibalization, and reduce range anxiety.

In some embodiments, one or more models are used to determine optimal locations of individual EV charging stations that are in high demand charging regions. The individual EV charging stations may be placed in locations that do not result in nearby EV charging stations cannibalizing the demand or profits of the EV charging stations.

Furthermore, in the following, various embodiments are described with respect to methods and systems for building an electric vehicle charging network. In some embodiments, a disclosed method includes: storing, in a database, historical data associated with existing electric vehicle charging stations, identifying a first set of locations for potential electric vehicle charging stations, determining demand forecast associated with the set of locations based on the historical data, generating a score value for each location of the first set of locations, the score value being based on the demand forecast, calculating a loss value for a first location of the first set of locations based on one or more of a second location of the first set of locations and a plurality of locations of the existing electric vehicle charging stations, and generating a second set of locations for potential electric vehicle charging stations based on the demand forecast, the score value, and the loss value, the second set being a subset of the first set.

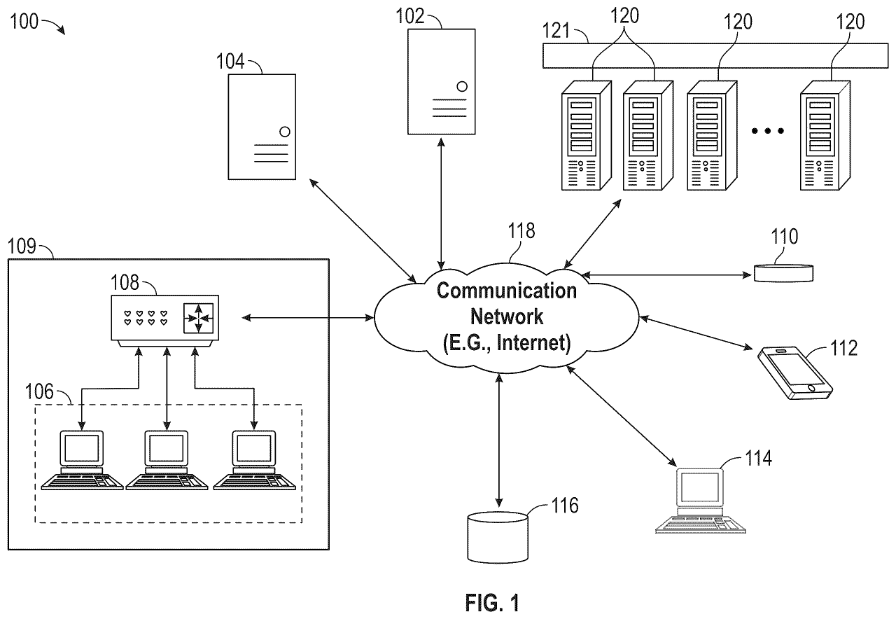

Turning to the drawings, FIG. 1 is a network environment 100 configured to build an electric vehicle charging network, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, EV charging network forecaster (“forecaster”) 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The forecaster 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the forecaster 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the forecaster 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more applications configured to provide locations of EV charging stations of an EV charging network.

The workstation(s) 106 are operably coupled to the communication network 118 via a router (or switch) 108. The workstation(s) 106 and/or the router 108 may be located at a store 109 of a retailer, for example. The workstation(s) 106 can communicate with the forecaster 102 over the communication network 118. The workstation(s) 106 may send data to, and receive data from, the forecaster 102.

Although FIG. 1 illustrates three user computing devices 110, 112, 114, the network environment 100 can include any number of user computing devices 110, 112, 114. Similarly, the network environment 100 can include any number of the forecaster 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website or application hosted by the web server 104. The web server 104 may transmit user session data related to a user's activity (e.g., interactions) on the website or application.

In some examples, a customer may operate one of the user computing devices 110, 112, 114 to initiate a web browser or application that is directed to a website or application hosted by the web server 104. The customer may, via the web browser, view a user interface for viewing and interacting one or more applications. The one or more applications may allow a user to view, interact with, and/or forecast EV charging station locations. In some embodiments, the applications capture these activities as user session data, and transmit the user session data to the forecaster 102 over the communication network 118.

In some embodiments, the web server 104 transmits a request to the forecaster 102, e.g. based on a user's request for a forecast of potential locations for EV charging stations of an EV charging network. For example, the request may be sent based on a user providing an input into an application. The request may be sent standalone or together with other related data of the application (e.g., a website). In some examples, the request may carry or indicate user data.

In some examples, the forecaster 102 may execute one or more models (e.g., algorithms), such as a mathematical models, machine learning model, deep learning model, statistical model, etc., to provide an output to the user. The output may be presented on the user interface and/or may include a one or more optimal locations associated with an EV charging network. In some embodiments, the EV charging network is made up of individual EV charging stations. The EV charging stations may be fast-charging stations for charging an electric vehicle.

The forecaster 102 is further operable to communicate with the database 116 over the communication network 118. For example, the forecaster 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the forecaster 102, in some examples, the database 116 can be a local storage device, such as a hard drive, a non-volatile memory, or a USB stick. The forecaster 102 may store historical data, business metrics, user data, or data associated with one or more EV charging stations. Database 116 may be coupled to a computing device. For example, database 116 may be coupled to one or more user computing devices 110, 112, 114 via communication network 118.

In some embodiments, the web server 104 transmits a model training request to the forecaster 102. Upon the model training request, the forecaster 102 may retrieve, e.g. from the database 116, historical data associated with previous locations and/or uses of one or more EV charging stations. The forecaster 102 may train one or more models using the historical data. The one or more models may be trained to generate outputs for forecaster 102. The one or more models may be trained to generate outputs for forecaster 102 based on a request from a user. In some embodiments, the one or more models are configured to receive feedback from the user to refine or retrain the one or more models. For example, a user may transmit a request to forecaster 102. Forecaster 102 may provide optimal locations for EV charging stations for an EV charging network. The user may transmit a subsequent request to forecaster 102 including adjustments to the one or more locations. Forecaster 102 may provide updated or refined locations and/or may refine one or more models based on the subsequent request of the customer.

In some embodiments, the outputs from the model may be used to refine and train the model. For example, one or more models may be trained using historical data (e.g., previous use of one or more EV charging stations) and may generate optimal locations for future EV charging stations to form an EV charging network. Forecaster 102 may receive adjustment or refinement data associated with whether the user made or requested additional adjustments or refinements to the generated outputs. The adjustment data may be inputted into the one or more models such that the one or more models compares the adjustments to the generated outputs to generate a comparison value. The greater the comparison value the greater the deviation the adjustment is from the generated route. In other words, the greater the comparison value, the less accurate the one or more models are. In some embodiments, the comparison value may be inputted into the one or more models to refine the one or more models to make the one or more models more accurate.

In some examples, the forecaster 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the forecaster 102 may generate a plurality of locations for EV charging stations to optimize an EV charging network.

In some embodiments, forecaster 102 is configured to forecast resource allocations. For example, forecaster 102 may provide a plurality of optimized journeys to minimize the amount of empty and/or inefficient miles. Forecaster 102 may generate a plurality of optimized routes based on a user's request.

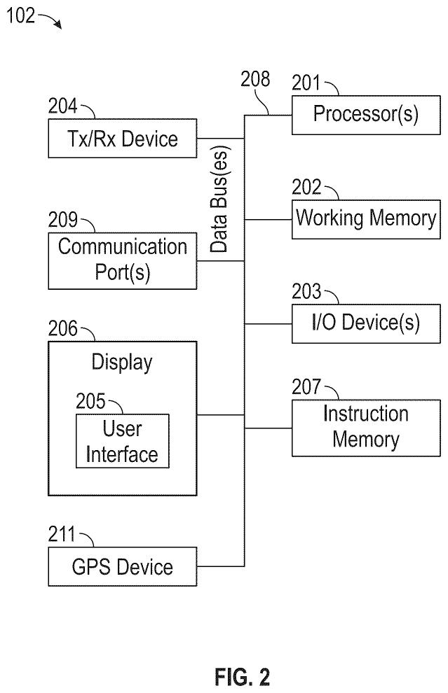

FIG. 2 illustrates a block diagram of an EV charging network forecaster, e.g. the forecaster 102 of FIG. 1, in accordance with some embodiments of the present teaching. In some embodiments, each of the forecaster 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the forecaster 102 can be combined, omitted, and/or replicated. In addition, it will be appreciated that additional elements other than those illustrated in FIG. 2 can be added to the forecaster 102.

As shown in FIG. 2, the forecaster 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the forecaster 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the forecaster 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the forecaster 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the forecaster 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the forecaster 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the forecaster 102 and/or the web server 104. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the forecaster 102 may determine a local geographical area (e.g., town, city, state, etc.) of its position.

In some embodiments, the forecaster 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the forecaster 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data may include historical data of one or more EV charging stations. For example, the training data may include historical data associated with the use, location, profitability, distance, and/or power consumption of one or more EV charging stations comprising an EV charging network. Further, the training data may include historic data, typically for one or more years. Further, the training system is configured to receive feedback information at least through the graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained models to provide more accurate outputs. This allows the models to be refined to provide accurate generated outputs.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information through the graphical user interface corresponding to actions by the recipient interfacing with the graphical user interface.

The above and below description includes descriptions of embodiments implementing and/or utilizing trained machine learning models and/or neural networks. For example, the systems and methods described herein may utilize one or more natural language processing (NLP) models to process spoken language. In some embodiments, the neural network, machine learning models and/or machine learning algorithms may include, but are not limited to, Large Language Models (LLM), Heuristics, Univariate based techniques, Multivariate, control limit, isolation forest and LOF—ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

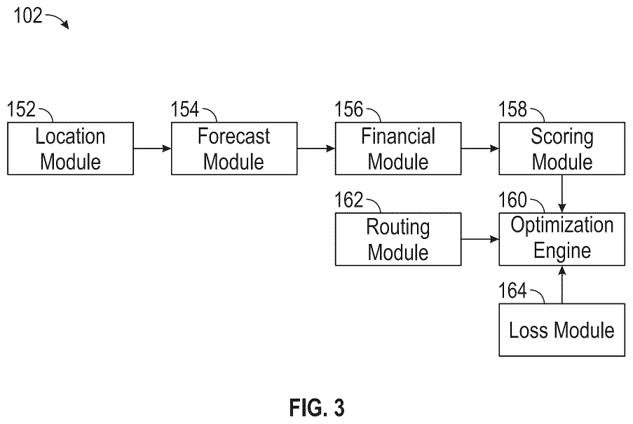

FIG. 3 is a block diagram of forecaster 102, in accordance with some embodiments of the present teaching. As indicated in FIG. 3, forecaster 102 may include location module 152, forecast module 154, financial module 156, scoring module 158, optimization engine 160, routing module 162, and loss module 164. Location module 152 may be configured to identify viable locations where EV charging stations of an EV charging network can be installed and placed. In some embodiments, the viable locations may be inputted into one or more models utilized by forecast module 154. Forecast module 154 may be configured to estimate demand for each location of the EV charging stations of the EV charging network. For example, forecast module 154 may utilize one or more models to estimate a forecasted demand of each EV charging station of the EV charging network. Location module 152 may transmit location data including the potential locations for one or more EV charging stations of an EV charging network to forecast module 154, which may input the location data into one or more models to generate a forecasted demand for each EV charging station.

In some embodiments, the one or more models utilized by forecast module 154 are trained using historical data of existing EV charging stations. For example, existing EV charging stations may generate usage data including how often each station is used, how long each station is used, the power consumption of each station, etc. The usage data may be used to train one or more models to generate potential locations for future EV charging stations of an EV charging network. In some embodiments, the usage data originates from third-party sources (e.g., third party EV charging networks/stations). Forecast module 154 may receive the location data associated with EV charging stations of an EV charging network from location module 152 and input the location data into one or more modules to generate a forecasted demand (e.g., demand data) for each EV charging station.

Forecast module 154 may transmit the demand data to financial module 156. Financial module 156 may be configured to convert the demand data into financial data. The financial data may include forecasted revenue, net present value (NPV), and internal rate of return (IRR). In some embodiments, financial module 156 is configured to assess the financial viability and profitability of building an EV charging network based on installing the EV charging stations at the locations identified by location module 152. In some embodiments, financial module 156 utilizes one or more modules to generate the financial data. For example, financial module 156 may input the demand data from forecast module 154 into one or more modules to output financial data.

Scoring module 158 may be configured to generate a score associated with the demand data and financial data for each identified location of each EV charging station of the EV charging network. Scoring module 158 may be configured to generate a score (e.g., score data) and transmit the score to optimization engine 160. The score may indicate relative preference of a location over other locations in terms of suitability for installing EV charging station.

In some embodiments, forecaster 102 includes loss module 164 configured to identify cannibalization loss estimations for a location of an EV charging station of the EV charging network based on nearby EV charging stations. For example, an EV charging station that is in a location above a predetermined distance threshold from a planned EV charging station may be found to not cannibalize on the demand of the planned EV charging station. Conversely, an EV charging station that is in a location within a predetermined distance threshold from a planned EV charging station may be found to cannibalize on the demand of the planned EV charging station and reduce the demand and profitability of the planned EV charging station. Loss module 164 may generate loss data associated with cannibalization loss estimates for a location of an EV charging station based on nearby EV charging stations.

Forecaster 102 may include routing module 162 configured to identify traffic routes. For example, routing module 162 may identify traffic routes where range anxiety is most likely to impact users of the EV charging network. In some embodiments, routing module 162 generates routing data based on based on a determination of traffic routes where range anxiety would impact users of the EV charging stations. Range anxiety occurs when a user of an EV becomes concerned that their vehicle will lose charge between EV charging stations. Routing module 162 may be configured to identify traffic routes where distance between existing EV charging stations are great enough to cause range anxiety.

In some embodiments, routing module 162 transmits the routing data to optimization engine 160. Scoring module 158 may transmit score data to optimization engine 160 and loss module 164 may transmit loss data to optimization engine 160. Optimization engine 160 may be configured to identify a plurality of location sites for placement of an EV charging station of an EV charging network based on the routing data, the score data, and the loss data.

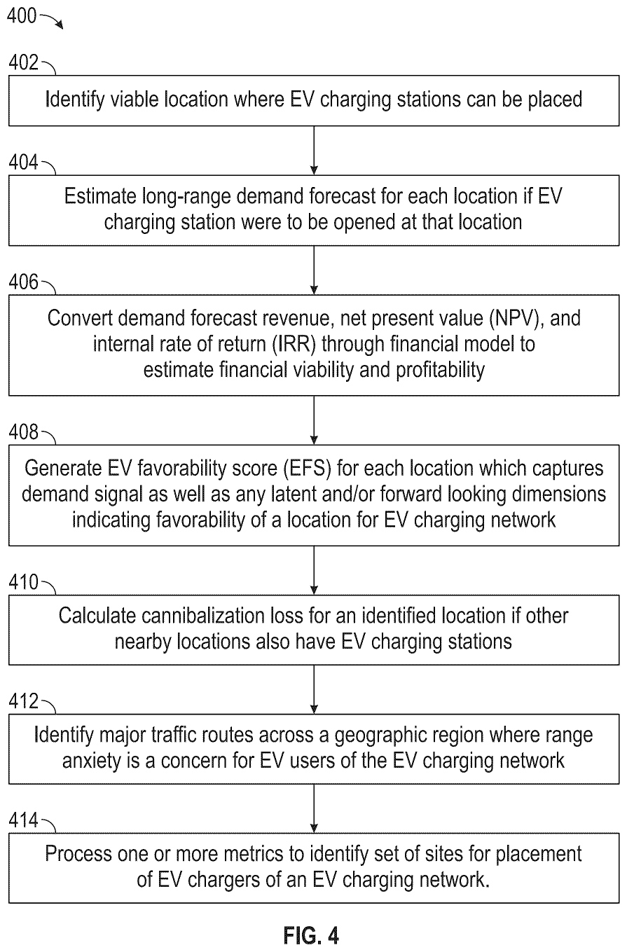

FIG. 4 illustrates an exemplary method of using forecaster 102 and is detailed below with reference to FIG. 3.

At step 402, location module 152 identifies set of locations for EV charging stations of an EV charging network. The identified locations are identified through set of pair of latitude-longitude coordinates or set of street addresses. The set of locations can be any group of locations, or even all locations in a given geography. For example, every 1-mile by 1-mile square in the region can be used to identify the set of locations for EV charging stations to from an EV charging network.

At step 404, given a location identified by location module 152, forecast module 154 may estimate long-term demand forecast to provide expected power consumption (e.g., kWh of energy sale) if an EV charging station is opened at that location. Long-term is defined as a period over which financial viability is to be calculation, which is typically 10-15 years. Forecast module 154 may utilize one or more models to forecast demand based on historical uses of existing EV charging stations and driving factors. Forecast module 154 may forecast demand (e.g., power/energy consumption) at a location where an EV charging station does not yet exist. In some embodiments, driving factors include number of EVs in specific area, quantum of traffic passing through the location, presence of charging competition, number of vehicles and size of population in the neighborhood, number of trips starting or ending in the vicinity of the location, presence of freeways nearby, presence of commercial activities of interest nearby, etc. In some embodiments, demand forecast generated by forecast module 154 includes estimations of potential energy sale if the EV charging station is opened at the identified location.

At step 406, financial module 156 is configured to convert demand forecast from forecast module 154. In some embodiments, the demand forecasts are converted into revenue via pricing assumptions. The revenue may be converted into cashflow projections through suitable inputs in capital and operating expenditures, subsidies, taxes, etc. to infer financial viability of the identified location. In some embodiments, an identified location with high demand may not be financially viable because of high input cost of energy in the region which increases the operating cost, while another location with a moderate demand may be financially viable because of government subsidies (e.g., federal or state grants) offered for EV charging infrastructure (e.g., EV charging network) at that location.

In some embodiments, financial module 156 utilizes one or more models to generate financial data, such as internal rate of return (IRR), net present value (NVP), or other financial metrics for each identified location based on the demand forecasts. In some embodiments, the one or more models are configured to calculate a discount rate at which the net present value (NPV) becomes zero. An identified location may be considered financially viable if the IRR is higher than a desired hurdle rate (e.g., function of inputs from Weighted Average Cost of Capital (WACC)) for the owner of the EV charging network. In some embodiments, financial module 156 is configured to output financial data including NPV and IRR for each identified location based on the forecast demand.

At step 408, scoring module 158 is configured to generate an EV favorability score (EFS) for each identified location which captures the demand signal in addition to latent and/or forward looking (e.g., advancements in technology, changes in policy) for an identified location of an EV charging station of an EV charging network.

In some embodiments, upon the completion of step 406, forecaster 102 generates a ranking of identified locations based on their individual financial viability. The financial viability may be driven by individual demand forecasts (e.g., forecasted demands generated by forecast module 154). The demand forecasts and financial estimates (e.g., generated by financial module 156) may be generated by one or more models based on the models being trained by historical data (e.g., historical usage of existing EV charging stations). In some embodiments, forecaster 102 (e.g., scoring module 158) uses one or more models to take into account changes not reflected in the historical data, such as changes in technologies (e.g., various charging adapters for different EVs, increase in battery ranges, decrease in battery charging times), changes in policies, changes in subsidies, changing demographics of identified locations, etc.

Scoring module 158 may utilize one or more models to combine intelligence from both historical and future affecting latent dimensions (e.g., through inputs from subject matter experts and/or forecasting models). In other words, scoring module 158 may compute an EFS for each identified location based on forecasted demand, financial metrics, and future affecting latent dimensions (e.g., technology changes, policy changes, demographic changes, etc.). Scoring module 158 may be configured to generate an EFS for each identified location, and based on the EFS, rank and prioritize each identified location.

In some embodiments, scoring module 158 is configured to convert the latest current information from historical utilization into a linear function of independent driving factors of demand. For example, expected utilization (kWh) consumption of an identified location were an EV charging station is to be placed at that location is generally expected to be driven by number of EVs in specific area (e.g., neighborhood), quantum of traffic passing through the location, presence of charging competition, number of vehicles and size of population in the specific area, number of trips starting or ending in the vicinity of the location, presence of freeways nearby, presence of commercial activities of interest nearby, existing footfalls at that location, etc. Using one or more models, scoring module 158 is configured to generate weights of each of these factors to closely reflect the expected utilization at the identified location. In some embodiments, scoring module 158 uses the following function to generate weights:

$${U}_{i} = {\sum }_{j = 1}^{j = v} {β}_{j} {Z}_{i j}$$

Where, Uᵢ is utilization demand at location i, Zᵢⱼ is value of a driving factor j for the location i, and βⱼ is machine model driven weight of the driving factor j. Zᵢⱼ are normalized to have value between 0-1 so that difference in the scale of different factors is not crucial (for instance, vehicle count may be in thousands, while applicability of subsidy may be binary). Therefore all βⱼ are on scale and comparable to each other. There are v such driving factors.

Zᵢⱼ for j=(v+1) . . . w are additional (w−v) latent factors not part of initial Zᵢⱼ (where j=1 . . . v). For example, latent factors may include EV purchase subsidies available at the identified locations, incidence of crime at the identified location, favorability of local politics at the identified location, or ease of working with local utility provider at the identified, etc.

In some embodiments, scoring module 158 receives external inputs from third party sources (e.g., industry experts, policy makers, domain subject matters, think tanks, policy influences, etc.) to obtain relative ranking and prioritization of all w driving factors. This input can take form of grouping of driving factors into different groups, and relative ordering of these groups. For example, w factors can be grouped into k groups, where 1≤k≤w, such that each group has one or more of driving factors.

Each group may have a defined order (1 being highest and k being lowest) as provided by external inputs which captures any latent or strategic consideration. This way of capturing information has benefit of being able to capture all potential feedback, including up- or down-weighting of certain factors, non-importance of other factors, etc.

In some embodiments, two formulations for computing revised weights combining both observed historical and future affecting latent dimensions are described below.

The first formulation is formulated as a constrained optimization to learn revised weights such that expert group rankings are considered while weights are kept as close to original as possible to achieve the optimal combination at minimal loss of information.

Let dⱼ be +1 or −1 representing the direction of influence of the weight such that βⱼ=dⱼ|βⱼ|, let γⱼ=dⱼ|γⱼ| be revised weights.

Objective function of the optimization is to keep revised weights as close to the original as possible, or mathematically:

$$Minimize {\sum }_{j = 1}^{j = w} {( \vert {β}_{j} \vert - \vert {γ}_{j} \vert )}^{2}$$

Since prior weights of newly added latent factors are not available, old weights are taken as zero, i.e. |βⱼ|=0∀j=(v+1) . . . w

Below set of constraints ensures that expert driven order is maintained where absolute value of the revised weight of the factor belonging to higher order group (say, p) must be higher than the absolute value of the revised weight of the factor belonging to lower order group (say, q, where p<q since 1 represents the highest preference group), or mathematically:

$$\vert {γ}_{a} \vert \geq \vert {γ}_{b} \vert ∀ a ∈ p , b ∈ q , p < q$$

Further, domain expertise is applied to infer direction of newly added latent factors. For example, it is assumed that dⱼ∀j=(v+1) . . . w is known. For example, subsidies and ease of working should have positive direction and crime should have negative direction impact to the location's favorability.

Scoring module 158 may be configured to solve this first formulation through any of standard optimization algorithms (e.g. Gradient Descent) to generate the revised weights. In some embodiments, the optimization formulation is infeasible to solve. For example, when expert guidance differs drastically from historical weights (e.g., traffic has the lowest weight in historical demand, but expert input is it to have the highest score in site selection preference), then scoring module 158 may utilize a second formulation different than the first formulation.

For the second formulation, scoring module 158 may compute minimum and maximum value of the weights of each group (say, p) of driving factors:

$${r}_{p} = {min}_{j ∈ p} \vert {β}_{j} \vert$$

$${s}_{p} = {max}_{j ∈ p} \vert {β}_{j} \vert$$

Scoring module 158 may compute new minimum and maximum of each group, starting with lowest order group (kth), such that maximum of lower order group (say, q) becomes new minimum of next higher order group (say, p, where p=q−1)

$$= {s}_{q} , p = q - 1$$

If the new minimum of next higher order group ends up being higher than the old maximum of that group, then new maximum of next higher order group is calculated such that it maintains the difference in minimum and maximum seen for that group

$$= + ( {s}_{p} - {r}_{p} ) {s}_{p} \leq else = {s}_{p}$$

Scoring module 158 may compute revised weights through linear transformation for each group (say, p) of driving factors (say, j)

$$\vert {γ}_{j} \vert = ( \frac{-}{{s}_{p} - {r}_{p}} ) \cdot ( \vert {β}_{j} \vert - {r}_{p} ) + , j ∈ p$$

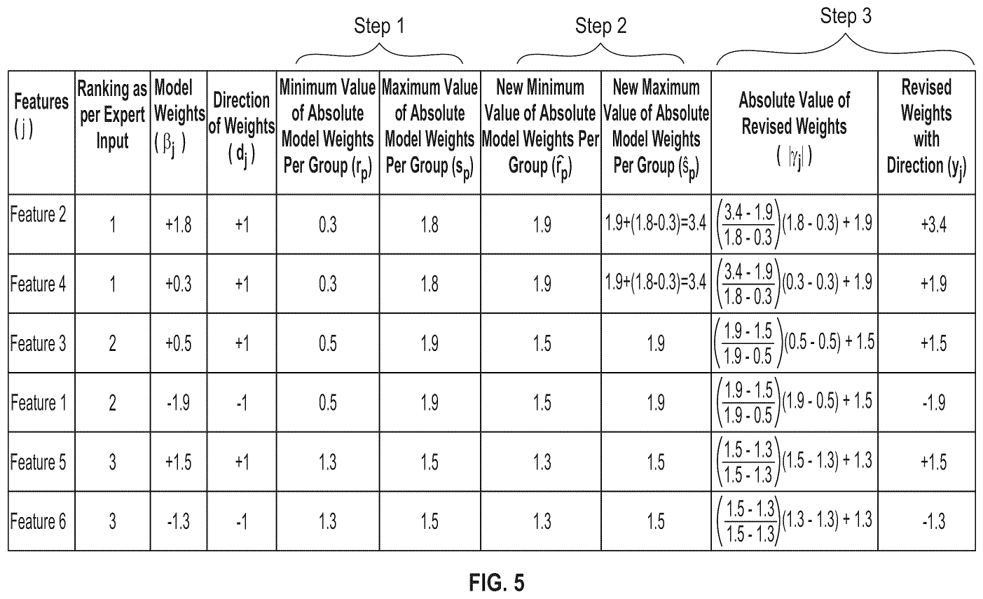

FIG. 5 provides a table illustrating the second formulation visually represented where six driving factors are grouped into three groups of two each.

Scoring module 158 may calculate the EFS based on:

$$EFS = {\sum }_{j = 1}^{j = w} {γ}_{j} {Z}_{ij}$$

Depending on quality and/or completeness of data available, revised weights from the first formulation and/or the second formulation can be used, or even combined together with weighted average of both.

Referring to FIG. 4, at step 410, loss module 164 calculate cannibalization loss (e.g., loss data) for an identified location if other nearby locations also have EV charging stations. While scoring module 158 generates an EFS that ranks each identified location independently, each identified location must be considered together to form an EV charging network where the individual EV charging stations are optimized together for their impact on each other. For example, although it is desirable to capture as large as market share as possible (e.g., to maximize portfolio profitability) and increase number of charging stations, if two EV charging station locations are too close to each other, then they are likely split potential users leading to self-cannibalization.

In some embodiments, an optimal distance is desirable between two identified locations for EV charging stations of an EV charging network to balance conflicting business interests of increased profitability and preventing self-cannibalization. However, the optimal distance between two locations is not deterministic as it depends on density of EV vehicles and presence of charging competition around the identified locations. For example, two sites can afford to be closer in high density city center but not in sub-urban or rural regions.

Below described methods estimate potential sales lost (due to cannibalization) to an existing charging location once a new EV charging station is opened close to an existing EV charging station. The output of a loss model utilized by loss module 164 is a set of percent shares, denominated by c(i→j, X) of the demand at location i lost to location j given a set of sites (X) to be opened. Here X=[xᵢ, . . . ]^{T} is a vector of xᵢ representing full network, such that xᵢ is a binary variable (i.e. takes value either 0 or 1) indicating which location is selected from universe of locations, where xᵢ=1 if location i is selected, and 0 otherwise. C(1→2, X)=25% means that 25% of demand at location 1 is lost due to charging station at location 2.

In some embodiments, loss module 164 utilizes a model based regression formulation to determine loss. Cannibalization formulation (e.g., loss determination) is estimated using one or more models where historical new locations coming up around existing locations are identified and calculate loss of demand to existing location, and then correlate that loss of demand to location specific drivers for both existing and new locations. The one or more models utilize a pre-post regression based analysis where loss is modeled in expected sales (i.e. EV Utilization demand) of an existing site i in presence of a new site j.

The training data for the one or more models utilized by loss module 164 is prepared by starting with existing network with earliest possible period for which information is available. Any new EV charging station location openings after that are considered as potential cannibalization events. For each new location, in order of the openings, the cannibalization (e.g., loss) is calculated for all nearby sites that are within a threshold distance of influence (e.g., within a 10 mile radius). Loss module 164 may estimate demand at location i in absence of a new EV charging station at location j using one or more models (e.g., a utilization forecast model). In some embodiments, loss module 164 measures the actual observed utilization demand of site i after opening of new site at j, and calculates a difference between the expected and actual utilization demand which is attributed to cannibalization.

While cannibalization/loss is the most likely reason for loss of demand, there may be other drivers of change in demand (say, pricing, or promotion, or change of EV count in region, etc.), a regression based method is employed to isolate just the effect of new location on demand while controlling for other characteristic of sites i, j, and other external environmental factors. In some embodiments, training data record is generated for a new EV charging location by linking cannibalization/loss with site attributes, demographics, and other potential contributing factors, etc.

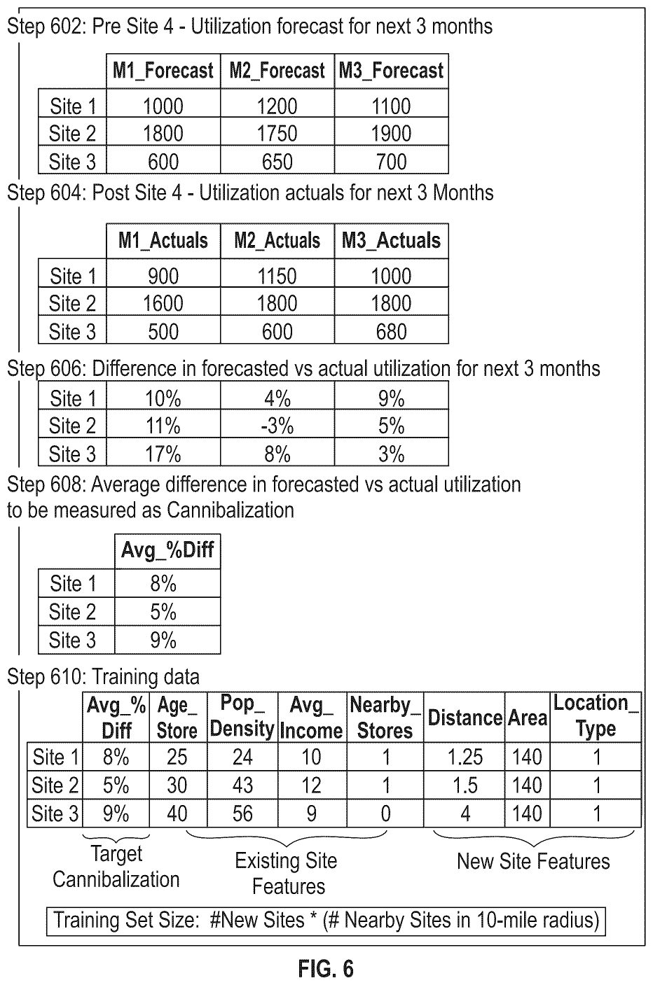

FIG. 6 illustrates a stepwise training data preparation process where three EV charging locations exist and a fourth EV charging location is to be opened at an identified location. At step 602, loss module 164 generates forecasted demand (e.g., utilization forecast) for each site (e.g., site 1, site 2, and site 3) for three months (e.g., M1, M2, and M3). At step 604, loss module 164 determines actual demand for each site (e.g., site 1, site 2, and site 3) for three months (e.g., M1, M2, and M3). At step 606, loss module 164 calculates the difference between the forecasted demand and actual demand for each site for three months. At step 608, loss module 164 calculates the average difference in forecasted demand compared to actual demand. At step 610, loss module 164 generates training data based on the average difference to forecast loss upon opening of a fourth site within a 10 mile radius.

In some embodiments, loss module 164 utilizes a regression algorithm (e.g., random forest or neural network) to estimate percentage cannibalization (e.g., loss) based on the generated training data. The learned regression algorithm is desired function C(i→j, X). A plurality of factors correspond to original site i and new site j may be used and may be related to site, demographics, location, EV, and competition. For example, factors relating to the site may include site type, age, area (size), location, urbanicity, monthly visits, monthly sales, EV utilization, retail stores, and/or distance to new location. Factors relating to demographics may include population density, per capita income, households, commercial establishments, and/or environmental consciousness of neighborhood. Factors relating to location may include nearby freeway and daily traffic. Factors relating to EV may include current EV registrations and future EV forecast. Factors relating to competition may include nearby EV stations and/or availability of free charging nearby.

In some embodiments, due to the lack of historical data due to EV charging networks being relatively new, inference loss may be difficult requiring loss module 164 to utilize one or more models to determine cannibalization/loss. Loss module 164 may utilize a gravity based cannibalization/loss estimation model. For example, loss module 164 may utilize the below function based on cannibalization being a function of distance between two locations:

$$C ( i \to j , X ) = \{ \begin{matrix}\frac{1}{2} {( 1 - \frac{{D}_{ij}}{{D}_{m ax}} )}^{2} , & {D}_{ij} \leq {D}_{m ax} \\ 0 , & {D}_{ij} > {D}_{m ax}\end{matrix}$$

where Dᵢⱼ is the distance between two locations, and Dₘₐₓ is the distance of influence i.e. maximum threshold beyond which locations do not cannibalize each other. In some embodiments, Dₘₐₓ=10 miles due to typical EV driver/users preference to not drive more than 10 miles off a desired course to charge. However, Dₘₐₓ may be any distance desired.

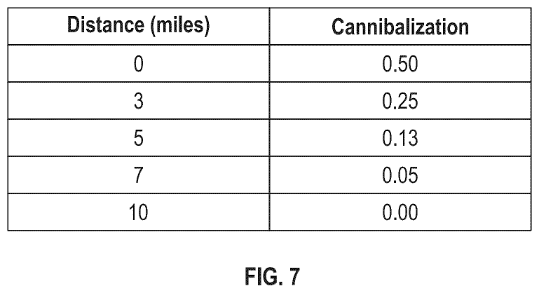

FIG. 7 shows a table illustrating the impact of cannibalization with the distance for select distance examples. For example, if two locations are exactly at the same location (Dᵢⱼ=0) then they each service half the demand (e.g., cannibalization/loss of 0.50). Depending on quality and/or completeness of data available, cannibalization/loss can be computed through pre-post regression based analysis model, a gravity based cannibalization/loss estimation model, or a weighted average of both.

Referring back to FIGS. 3-4, at step 412, routing module 162 is configured to identify routes, such as major traffic routes, across a geographic location where range anxiety would be a concern for EV users of the EV charging network. In some embodiments, routing module 162 is configured to identify specific routes associated with range anxiety. For example, routing module 162 may identify one or more routes where placement of an EV charging station of an EV charging network would reduce range anxiety. In some embodiments, each route is encoded through a set of latitude-longitude coordinates across the route at predetermined distance intervals (e.g., every 1 mile). The predetermined distance intervals may be every 0.1 miles, every 0.25 miles, every 0.5 miles, every 2 miles, every 3 miles, every 5 miles, every 10 miles, every 25 miles or greater than every 25 miles. Routing module 162 may be configured to identify routes very a manual process, an automated process using one or more machines and/or models, or using historical data.

In some embodiments, routing module 162 is configured to segment each route. A segment of each route is defined to be “covered” if there is an EV charging station within a predetermined range distance (e.g., 150 miles) of a segment on both directions of the route, and the EV charging station is within a threshold distance (e.g., 2 miles) of the route. This may prevent long detours allowing the user of the EV charging network to easily charge their EV without having range anxiety. In some embodiments, the predetermined range distance is between 0 miles and 300 miles, 1-miles and 250 miles, 50 miles to 150 miles, or greater than 300 miles. In some embodiments, the threshold distance is between 0 miles and 5 miles, 5 miles and 10 miles, or greater than 10 miles.

In some embodiments, routing module 162 identifies a plurality of major national routes (e.g., through business judgment, or through observing corridors of high traffics).

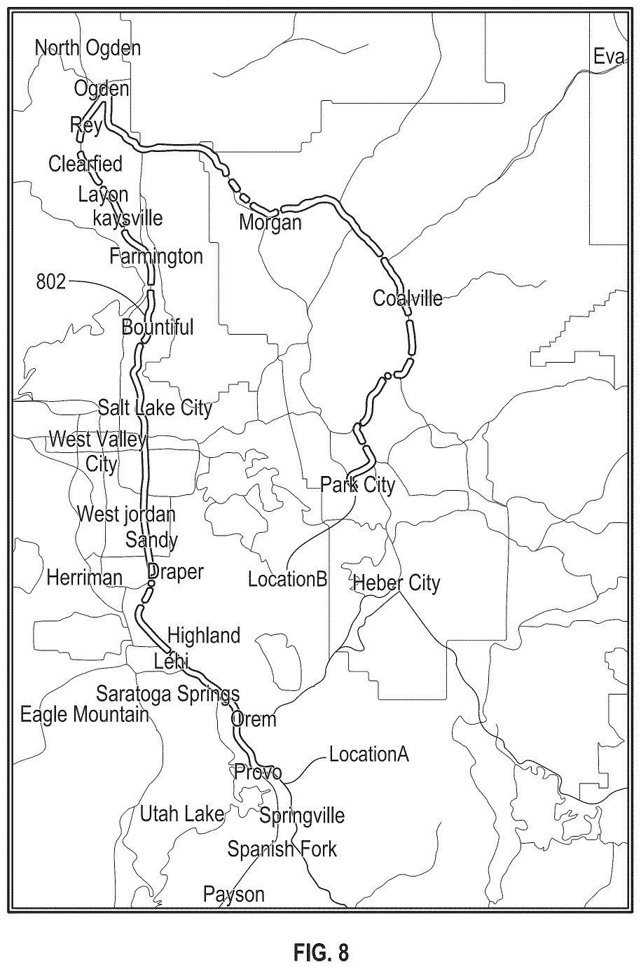

FIG. 8 illustrates an example of a route between two locations (e.g., Location A and Location B). Route 802 may be a route between Location A and Location B. Forecaster 102 (e.g., via routing module 162) is configured to determine locations for placing of EV charging stations at multiple locations along high traffic routes to alleviate range anxiety of EV users. In some embodiments, routing module 162 uses 150 miles between locations of a route as the maximum desirable distance between two charging stations where range anxiety is reduced and/or managed. This distance may be greater or less than 150 miles depending on the range of EV batteries.

Further, a user of the EV charging network using an EV to drive along route 802 may not want to take long detour from the route to charge their EV, and hence routing module 162 identifies locations on route 802 only if it is within certain threshold distance (e.g., 2 miles) of route 802.

Combining both of above parameters, for a given route (e.g., route 802), routing module 162 determines a sub-set of locations along or adjacent to the route for EV charging station placement. In some embodiments, for a given location, routing module 162 is configured to identify a segment or portion of a route which can be considered “covered.” In other words, an EV driver can travel over those routes without worrying about running out of EV chargers as charging stations are placed conveniently at frequent distance without significant detour.

Referring to FIGS. 3-4, optimization engine 160 may be configured to process one or metrics (e.g., from forecast module 154, financial module 156, scoring module 158, routing module 162, and/or loss module 164) to identify locations for placement of one or more EV charging stations to form an EV charging network. Optimization engine 160 may receive EFS from scoring module 158 for individual locations (e.g., identified by forecast module 156) and output one or more locations for placement of one or more EV charging stations to build a network of EV charger stations that maximizes financial performance, reduces self-cannibalization, and reduces the range anxiety. In some embodiments, the one or more locations generated by optimization engine 160 maximizes the average EFS and the average NPV, and minimizes cannibalization/loss, while covering all the identified routes.

In some embodiments, optimization engine 160 utilizes a combinatorial search optimization approach. Let xᵢ be binary variable (i.e. takes value either 0 or 1) indicating which location is selected from universe of N such locations, where xᵢ=1 if location i is selected, and 0 otherwise. Then X=[xᵢ, . . . ]^{T} will be a vector of xᵢ representing full network. Number of such locations selected is count of xᵢ which are 1s, or in other words, sum of xᵢ.

$$n = {\sum }_{i = 1}^{i = N} {x}_{i}$$

If eᵢ be the corresponding EFS of location i then, average EFS is calculated as

$$E = \frac{{\sum }_{i = 1}^{i = N} {e}_{i} {x}_{i}}{n}$$

Further, let F(X) be a function calculating portfolio level NPV, which is function of individual location level NPV after adjusting for impact of cannibalization based on presence of other nearby locations.

If C(i→j, X) is a function returning a fraction (between 0 and 1) of demand lost from location i after another charging station is opened at location j (obtained through formulation in Step 5) given a network of locations, then

$$F = \frac{{\sum }_{i = 1}^{i = N} NPV [ {U}_{i} * \{ 1 - ( {\sum }_{j = 1 , j \neq i}^{j = N} C ( i \to j , X ) {x}_{j} ) \} ] \cdot {x}_{i}}{n}$$

Where NPV[U] is financial model configured to convert location level utilization demand into NPV. Portfolio level NPV is average of NPV of all selected sites, where utilization of selected site is reduced by sum of demand lost to all other selected sites. Averaging NPVs ensures that optimization does not select each and every location with positive NPV even if it has low IRR, while also ensuring that optimization does not limit itself to very few the most profitable locations.

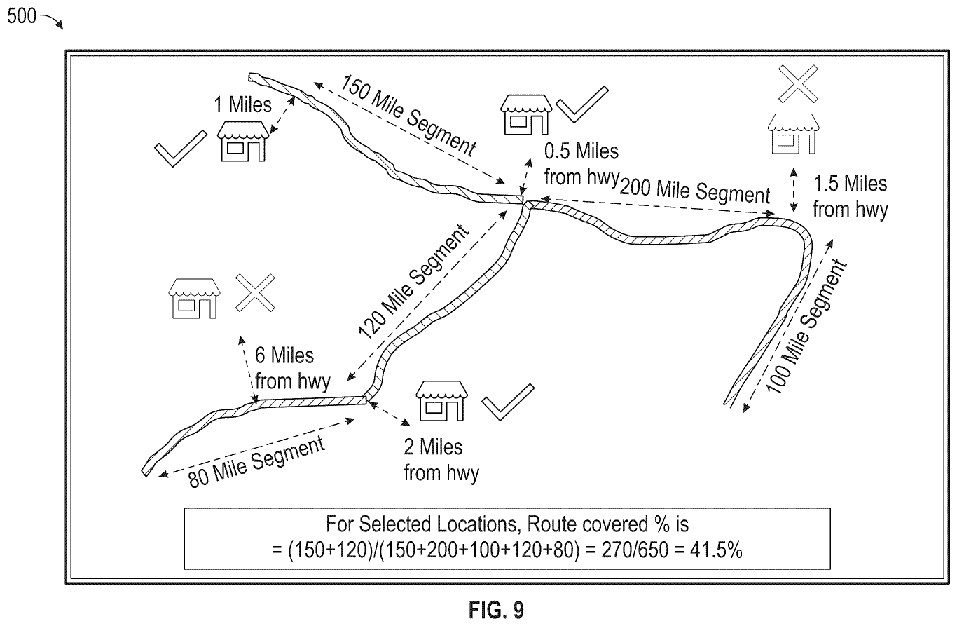

FIG. 9 is an illustration of a Route Coverage function G(X) which provides a percent number indicating part of distance along selected routes where a selected EV charging station is within 150 (or less) miles away in each direction.

Constraint of multi-objective formulation specify G(X)≥s, where minimum s % of route is desired to be covered. s % is a user specified parameter which can take any value from 0% to 100%. In some embodiments, optimization function is solved by Non-dominated Sorting Genetic Algorithm II (NSGAII). The NSGAII algorithm follows the general outline of a Genetic Algorithm with a modified mating and survival selection. This allows for the solving of a multi-objective problem—objectives E and F, both—subject to above constraint on G to give a set of non-dominated solutions forming the Pareto Frontier.

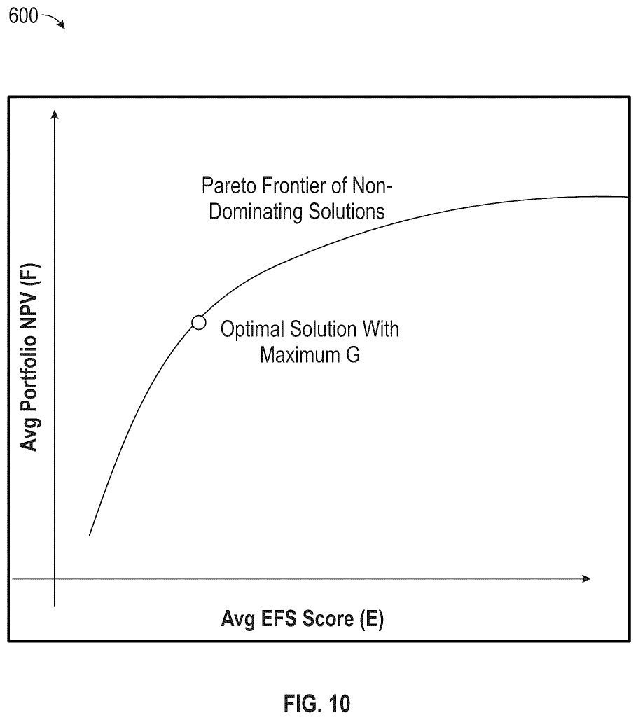

As shown in FIG. 10, every point in the Pareto Frontier is optimal solution—specifying full network of EV charging station locations—such that there is no point on this frontier where we can improve both the objective functions simultaneously. Moving along the frontier will necessarily only improve one of the objectives at the cost of the other—hence called non-dominant.

In some embodiments, optimization engine 160 generates a final set of locations based on the Route Coverage function G(X). Optimization engine 160 may be configured to generate one or more locations based on optimizing X where G(X) is maximized. In some instances where no such solution exists (e.g., G(X) is same for all the points on the Pareto Frontier of FIG. 10) then other business considerations can be applied to select point on the frontier.

In practice, we have other constraints which can help narrow the choice. Optimization formulation is generic enough to handle these constraints. Some examples of these other constraints are:

Inclusion of specific locations for placement of EV charging stations of an EV charging network for strategic reasons beyond EFS or IRR. In some embodiment, the inclusions of these specific locations impact NPV of other locations (through cannibalization) or route coverage
xᵢ=1 for i∈Must Include
xᵢ=0 for i∈Must Not Include

We must have certain minimum or maximum number of locations in the network:

$$MIN COUNT \leq n \leq MAX COUNT$$

Each location has certain Capital Cost of development (bᵢ) and overall budget (B) must be adhered to:

$${\sum }_{i = 1}^{i = N} {b}_{i} {x}_{i} \leq B$$

Certain routes are more important than others, hence desired route coverage is different per route (r):

$${G}_{r} \geq {s}_{r}$$

Optimization Engine 160 may weight each objective separately, such that sum of weight equals 1.0 and combine both objectives into single objective. In some embodiment, route coverage constraint can be converted into part of objective through triple-objective formulation or weighted single objective formulation.

Optimization engine 160 may capture one or more metrics from forecast module 154, financial module 156, scoring module 158, routing module 162, and/or loss module 164 and may utilize historical data to provide a holistic solution for selecting a portfolio of locations for placement of EV charging stations to form an EV charging network such that overall financial metrics are maximized, while unique EV specific consideration of range-anxiety is minimized.

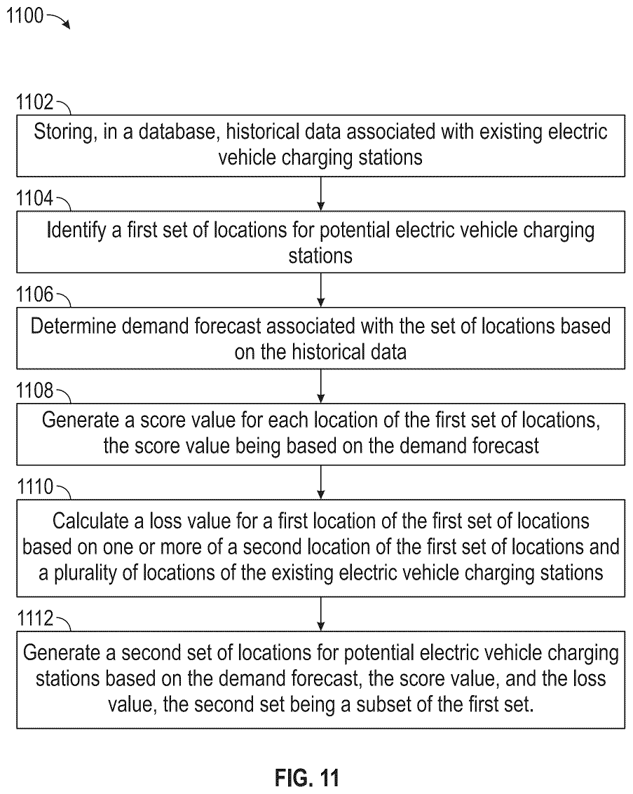

FIG. 11 is a flowchart illustrating an exemplary method for building an EV charging network. At operation 1102, forecaster 102 stores historical data within database 116. Forecaster 102 may receive historical data from one or more devices or third-party sources. The historical data may include data associated with the operation of one or more existing EV charging stations or networks. The data may include usage, power consumption, location, distance from another EV charger, etc. At operation 1104, forecaster 102 may identify a first set of locations. The first set of locations may be any viable location for placement of one or more EV charging stations to form an EV charging network. At operation 1106, forecaster 102 may be configured to determine demand forecast associated with each location of the first set of locations. The demand forecast may be forecasted usage metrics (e.g., power consumption, traffic, uses, duration of use, etc.) associated with placement of an EV charging station at each location of the first set of locations. At operation 1108, forecaster 102 may be configured to generate a score value (e.g., EFS) for each location of the first set. Forecaster 102 may be configured to score, rank, and prioritize the first set of locations. At operation 1110, forecaster 102 may be configured to calculate a loss value (e.g., cannibalization loss value) for a first location of the first set of locations. The loss value may be calculated based on nearby existing EV charging stations or nearby planned/potential EV charging stations. These nearby EV charging stations (existing or planned) may cut into the profitability of the EV charging station planned for each location of the first set.

At operation 1112, forecaster 102 may be configured to generate a second set of locations for potential electric vehicle charging stations. The second set may be one or more metrics (e.g., the score value, loss value, and/or demand forecast). The second set may be a subset of locations of the first set that includes a finalized set of locations that are viable and profitable locations for placement of one or more EV charging stations of an EV charging network. In some embodiments, the second set takes into consideration range anxiety for placement of EV charging stations within a predetermine threshold distance from a highly trafficked route and/or within a predetermined distance from another EV charging station. This results in reduced range anxiety for users of the EV charging network.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing historical data associated with existing electric vehicle charging stations;
a computing device comprising at least one processor in communication with the database, the computing device being configured to:
identify a first set of locations for potential electric vehicle charging stations;
determine demand forecast associated with the set of locations based on the historical data;
generate a score value for each location of the first set of locations, the score value being based on the demand forecast;
calculate a loss value for a first location of the first set of locations based on one or more of a second location of the first set of locations and a plurality of locations of the existing electric vehicle charging stations; and
generate a second set of locations for potential electric vehicle charging stations based on the demand forecast, the score value, and the loss value, the second set being a subset of the first set.

2. The system of claim 1, wherein the historical data includes electric vehicle population data, traffic data, charging station data, trip data, roadway data, or commercial data.

3. The system of claim 1, wherein the computing device is further configured to convert the demand forecast into a linear function to generate the score value.

4. The system of claim 3, wherein the computing device is further configured to generate a plurality of weights corresponding to a plurality of factors of the linear function.

5. The system of claim 1, wherein the loss value for the first location of the first set of locations is a share loss percentage corresponding to the second location of the first set of locations.

6. The system of claim 1, wherein the computing device is further configured to correlate a loss of demand to the plurality of locations of the existing electric vehicle charging stations to calculate the loss value for the first location of the first set of locations.

7. The system of claim 1, wherein the computing device is further configured to:
identify a plurality of route segments; and
identify each route segment of the plurality of route segments corresponding to a location of the plurality of locations of the existing electric vehicle charging stations.

8. A method comprising:
storing, in a database, historical data associated with existing electric vehicle charging stations;
identifying a first set of locations for potential electric vehicle charging stations;
determining demand forecast associated with the set of locations based on the historical data;
generating a score value for each location of the first set of locations, the score value being based on the demand forecast;
calculating a loss value for a first location of the first set of locations based on one or more of a second location of the first set of locations and a plurality of locations of the existing electric vehicle charging stations; and
generating a second set of locations for potential electric vehicle charging stations based on the demand forecast, the score value, and the loss value, the second set being a subset of the first set.

9. The method of claim 8, wherein the historical data includes electric vehicle population data, traffic data, charging station data, trip data, roadway data, or commercial data.

10. The method of claim 8, further comprising converting the demand forecast into a linear function to generate the score value.

11. The method of claim 10, further comprising generating a plurality of weights corresponding to a plurality of factors of the linear function.

12. The method of claim 8, wherein the loss value for the first location of the first set of locations is a share loss percentage corresponding to the second location of the first set of locations.

13. The method of claim 8, further comprising correlating a loss of demand to the plurality of locations of the existing electric vehicle charging stations to calculate the loss value for the first location of the first set of locations.

14. The method of claim 8, further comprising:
identifying a plurality of route segments; and
identifying each route segment of the plurality of route segments corresponding to a location of the plurality of locations of the existing electric vehicle charging stations.

15. A non-transitory computer readable medium having instructions stored thereon, wherein the instructions, when executed by at least one processor, cause at least one device to perform operations comprising:
storing, in a database, historical data associated with existing electric vehicle charging stations;
identifying a first set of locations for potential electric vehicle charging stations;
determining demand forecast associated with the set of locations based on the historical data;
generating a score value for each location of the first set of locations, the score value being based on the demand forecast;
calculating a loss value for a first location of the first set of locations based on one or more of a second location of the first set of locations and a plurality of locations of the existing electric vehicle charging stations; and
generating a second set of locations for potential electric vehicle charging stations based on the demand forecast, the score value, and the loss value, the second set being a subset of the first set.

16. The computer readable medium of claim 15, wherein the instructions cause the at least one device to perform operations further comprising converting the demand forecast into a linear function to generate the score value.

17. The computer readable medium of claim 16, wherein the instructions cause the at least one device to perform operations further comprising generating a plurality of weights corresponding to a plurality of factors of the linear function.

18. The computer readable medium of claim 15, wherein the loss value for the first location of the first set of locations is a share loss percentage corresponding to the second location of the first set of locations.

19. The computer readable medium of claim 15, wherein the instructions cause the at least one device to perform operations further comprising correlating a loss of demand to the plurality of locations of the existing electric vehicle charging stations to calculate the loss value for the first location of the first set of locations.

20. The computer readable medium of claim 15, wherein the instructions cause the at least one device to perform operations further comprising:
identifying a plurality of route segments; and
identifying each route segment of the plurality of route segments corresponding to a location of the plurality of locations of the existing electric vehicle charging stations.
